(19) United States
(12) Patent Application Publication
(10) Pub. No.: US 2025/0220063 A1
(43) Pub. Date: Jul. 3, 2025

(54) DATA PROCESSING METHOD, DEVICE, AND SYSTEM

(71) Applicant: Lenovo (Beijing) Limited, Beijing (CN)

(72) Inventors: Bojie YU, Beijing (CN); Rui MA, Beijing (CN); Qiang WU, Beijing (CN)

(21) Appl. No.: 19/000,659

(22) Filed: Dec. 23, 2024

(30) Foreign Application Priority Data
Dec. 27, 2023 (CN) 202311824621.7

(51) Int. Cl. H04L 65/65

(52) U.S. Cl. CPC H04L 65/65

(57) ABSTRACT

A data processing method is applied to a first server using a first transmission protocol and includes obtaining a first data packet transmitted by a second server using a second transmission protocol and converting the first data packet into a target format to generate a second data packet. The first data packet is generated at least based on data sent by a first-type client and a second-type client. The first-type client is configured as a control end, and the second-type client is configured to interact bidirectionally with the first-type client using a first interaction content. The second data packet is configured to be transmittable to a third-type client by the first server. The first transmission protocol is configured as a data transmission protocol, and the second transmission protocol is configured as a real-time communication protocol.

### CROSS-REFERENCE TO RELATED APPLICATION

The present disclosure claims priority to Chinese Patent Application No. 202311824621.7, filed on Dec. 27, 2023, the entire content of which is incorporated herein by reference.

### TECHNICAL FIELD

The present disclosure is related to the data processing technology field and, more particularly, to a data processing method, a data processing device, and a data processing system.

### BACKGROUND

Currently, live streaming technology based on the WebRTC protocol supports low-delay video calls. However, the live streaming technology based on the WebRTC protocol is suitable for a one-to-one single chat. Although the function is able to be expanded to realize group chat, the live streaming technology based on the WebRTC protocol does not focus on group chat and does not optimize for large-scale group chat. Thus, the live streaming has a significant delay. Especially for an interaction scenario in the live streaming, real-time interaction is not able to be realized due to the delay.

### SUMMARY

An aspect of the present disclosure provides a data processing method applied to a first server using a first transmission protocol. The method includes obtaining a first data packet transmitted by a second server using a second transmission protocol and converting the first data packet into a target format to generate a second data packet. The first data packet is generated at least based on data sent by a first-type client and a second-type client. The first-type client is configured as a control end, and the second-type client is configured to interact bidirectionally with the first-type client using a first interaction content. The second data packet is configured to be transmittable to a third-type client by the first server. The first transmission protocol is configured as a data transmission protocol, and the second transmission protocol is configured as a real-time communication protocol. The third-type client is configured to interact at least unidirectionally with the first-type client using a second interaction content. The first interaction content is different from the second interaction content.

An aspect of the present disclosure provides a data processing device, applied to a first server using a first transmission protocol. The device includes an acquisition module and a conversion module. The acquisition module is configured to obtain a first data packet transmitted by a second server using a second transmission protocol. The first data packet is generated at least based on data sent by a first-type client and a second-type client. The first-type client is configured as a control end. The second-type client is configured to interact bidirectionally with the first-type client using a first interaction content. The conversion module is configured to convert the first data packet into a target format to generate a second data packet. The second data packet is configured to be transmittable to a third-type client by the first server. The first transmission protocol is configured as a data transmission protocol. The second transmission protocol is configured as a real-time communication protocol. The third-type client is configured to interact at least unidirectionally with the first-type client using a second interaction content. The first interaction content is different from the second interaction content.

An aspect of the present disclosure provides a data processing system, including a second server and a first server communicatively connected. The second server is configured to obtain a first data packet transmitted by a second server using a second transmission protocol. The first data packet is generated at least based on data sent by a first-type client and a second-type client. The first-type client is configured as a control end. The second-type client is configured to interact bidirectionally with the first-type client using a first interaction content. The first server uses a first transmission protocol and is configured to convert the first data packet into a target format to generate a second data packet. The second data packet is configured to be transmittable to a third-type client by the first server. The first transmission protocol is configured as a data transmission protocol. The second transmission protocol is configured as a real-time communication protocol. The third-type client is configured to interact at least unidirectionally with the first-type client using a second interaction content. The first interaction content is different from the second interaction content.

### BRIEF DESCRIPTION OF THE DRAWINGS

FIG. 1 illustrates a schematic diagram showing an application scenario of a data processing method according to some embodiments of the present disclosure.

FIG. 2 illustrates a schematic flowchart of a data processing method according to some embodiments of the present disclosure.

FIG. 3 illustrates another schematic flowchart of a data processing method according to some embodiments of the present disclosure.

FIG. 4 illustrates another schematic flowchart of a data processing method according to some embodiments of the present disclosure.

FIG. 5 illustrates a schematic structural diagram of a data processing device according to some embodiments of the present disclosure.

FIG. 6 illustrates a schematic structural diagram of a data processing system according to some embodiments of the present disclosure.

### DETAILED DESCRIPTION OF THE EMBODIMENTS

Various modifications can be made to embodiments of the present disclosure. Thus, the present disclosure is not limited to embodiments of the specification. The embodiments of the specification are merely examples of embodiments of the present disclosure. Those skilled in the art can think of other modifications within the scope and spirit of the present disclosure.

The accompanying drawings included in the specification and forming a part of the specification illustrate embodiments of the present disclosure. The accompanying drawings can be used to describe the principle of the present disclosure with the general description of the present disclosure and the detailed description of the following embodiments.

With the description of non-limiting embodiments with reference to the accompanying drawings, features of the present disclosure can become obvious.

Although the present disclosure is described with reference to some embodiments, those skilled in the art can determine many other equivalent forms for implementing the present disclosure.

In connection with the accompanying drawings, based on the following detailed description, the above aspects, other aspects, features, and advantages of the present disclosure can become obvious.

Then, embodiments of the present disclosure can be described with reference to the accompanying drawings. However, the described embodiments are merely some embodiments of the present disclosure and can be implemented in various methods. Known and/or repetitive functions and structures are not described in detail to avoid unnecessary or excessive details that might obscure the present disclosure. Therefore, the structural and functional details of the present specification are not intended to limit the present disclosure but serve as a basis and representative basis for claims for teaching those skilled in the art to use the present disclosure in various suitable structural forms.

In the present specification, phrases “in one embodiment,” “in another embodiment,” “in another embodiment,” or “in other embodiments” can refer to one or more same embodiments or different embodiments of the present disclosure.

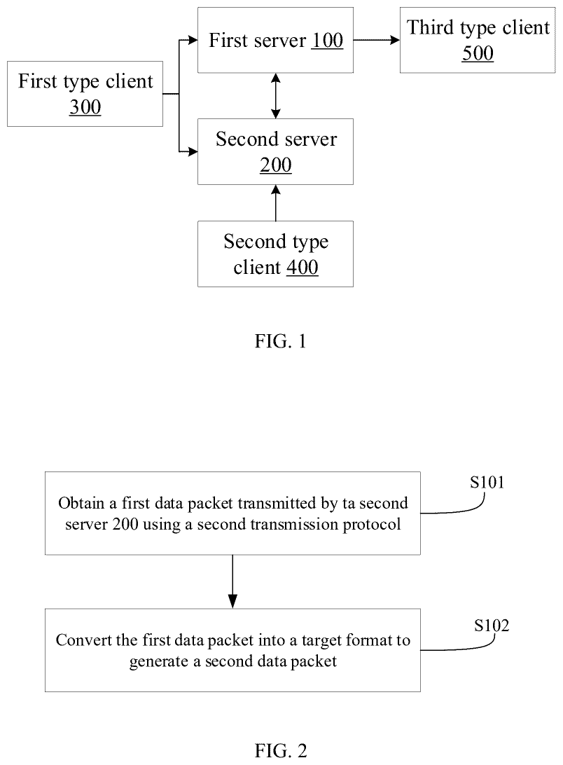

Embodiments of the present disclosure provide a data processing method applied to a first server 100 using a first transmission protocol. FIG. 1 illustrates a schematic diagram showing an application scenario of a data processing method according to some embodiments of the present disclosure. The data processing method can be applied to scenarios such as live streaming or online meetings.

As shown in FIG. 2, the data processing method includes step S101 and step S102:

At S101, a first data packet transmitted by a second server 200 using a second transmission protocol is obtained. The first data packet is generated at least based on data sent by a first-type client 300 and a second-type client 400. The first-type client 300 is configured as a control end, and the second-type client 400 is configured to interact bidirectionally with the first-type client 300 using a first interaction content.

A first-type user corresponding to the first-type client 300 can be understood as a “host” in live streaming or a “moderator” in an online meeting. The first-type client 300 can send data to the first server 100, the second server 200, or the first server 100 and the second server 200, respectively.

The first-type client 300 can run on the first equipment of the user configured to push media streaming data. The first equipment can be configured for live streaming or sharing various multimedia information such as videos, pictures, and voices in an online meeting. In a hardware aspect, the first equipment can include a smartphone, a PC, etc.

The second-type user corresponding to the second-type client 400 can be understood as a user who interacts with the first-type user in real-time, for example, a microphone connecting user with the “host” for a network live streaming scenario. The bidirectional interaction between the first-type client 300 and the second-type client 400 can have real-time performance and interactivity at a high level.

The second-type client 400 can send data to the second server 200, and the first server 100 can obtain data that is sent using the second transmission protocol through the second server 200. The second-type client 400 can run on the second equipment of the user configured to receive and push the media streaming data. In practical applications, the second equipment can be equipment configured to perform the network live streaming or sharing multi-media information such as videos, pictures, and voices in a network online meeting. On the hardware aspect, the second equipment can include a smartphone, a PC, etc.

The data included in the first data packet can be generated based on the interaction between the first-type client 300 and the second-type client 400.

At S102, the first data packet is converted into a target format to generate a second data packet. This second data packet is configured to be transmitted to a third-type client 500 by the first server 100. The first transmission protocol is configured as a data transmission protocol, and the second transmission protocol is configured as a real-time communication protocol. The third-type client 500 is configured to at least perform a single directional interaction with the first-type client 300 with the second interaction content. The first interaction content is different from the second interaction content.

The third-type user corresponding to the third-type client 500 can be understood as a reception end, which is configured to receive the data generated by the interaction between the first-type client 300 and the second-type client 400. For example, for the network live-streaming scenario, the third-type user can be a viewing user. The third-type client 500 can only receive the second data packet sent using the first transmission protocol configured as the data transmission protocol. Thus, the third-type user can watch the interaction between the first-type user and the second-type user.

Transmitting the data by the first server 100 using the first transmission protocol can reduce the restriction on the number of the third-type client 500 compared to transmitting the data by the second server 200 using the second transmission protocol. That is, the restriction on the number of people watching the live streaming can be reduced. The data can be distributed to more third-type clients 500.

At least single-directional interaction can mean that the third-type client 500 can receive the data generated by the first-type client 300 in one direction. That is, the third-type client can receive the information passively, i.e., the viewing user can receive the information. Of course, the third-type client 500 can also interact with the first-type client 300 by sending the information (e.g., a bullet comment). Whether the third-type client 500 sends the information can be determined by the third-type user. The third-type user can choose to not send the information or send the information. That is, the first interaction content between the first-type client 300 and the second-type client 400 can include audio content different from the audio content included in the second interaction content between the first-type client 300 and the third-type client 500. Obviously, compared to the real-time bidirectional interaction between the first-type client 300 and the second-type client 400, the interaction between the third-type client 500 and the first-type client 300 can be a single-directional interaction or a bidirectional interaction. However, the interaction forms and contents of the first-type client 300 and the second-type client 400 can be different.

The first transmission protocol can be the SRT (Secure Reliable Transport) protocol or another protocol capable of secure, reliable, low-delay high-definition network video transmission and distribution between a plurality of ends, which is not limited in embodiments of the present disclosure.

The second transmission protocol can be the WebRTC (Web Real-Time Communications) protocol or another real-time communication protocol that can facilitate video communication, which is not limited to embodiments of the present disclosure.

In some embodiments, the target format can be understood as a video transmission format. The data corresponding to the target format can be transmitted through the first transmission protocol. For example, the standard video transmission format based on MPEG-2 can be an MPEG-2 TS format, which can be used for transmission in the fields of digital video, broadcasting, digital television, high-definition video storage, etc. A plurality of data streams such as videos and audio can be packaged into an integral transmission stream.

In the present disclosure, the first data packet transmitted by the second server 200 using the second transmission protocol can be obtained and converted into the target format to generate a second data packet. Thus, the first data packet transmitted based on the second transmission protocol can be converted into the second data packet transmitted based on the first transmission protocol. The second data packet can be transmitted out using the first transmission protocol that is configured as the data transmission protocol to solve the problem of significant delay. Thus, the interaction between the first-type client 300 and the second-type client 400 can be transmitted to the third-type client 500 in real-time. Especially for the interaction scenario, the second-type client 400 can transmit data to the second server 200 to enhance the interaction effect of the interaction scenario, which realizes real-time interactive performance and enables the third-type client 500 to synchronously obtain the interaction content.

In some embodiments, the data processing method can also include configuring the first-type client 300 to send data to the first server 100 or to the first server 100 and the second server 200 in a first target scenario. The second-type client 400 can be configured to send data to the second server 200.

Thus, for the first target scenario, the second-type client 400 can be directly connected to the second server 200 to solve the problem of interaction delay when the second-type client 400 is connected to the first server 100. Thus, the interaction between the first-type client 300 and the second-type client 400 can be in real-time.

The first target scenario can be understood as an interaction scenario, i.e., the interaction between the first-type client 300 and the second-type client 400. Transmitting data using the second transmission protocol can have better real-time performance compared to transmitting data using the first transmission protocol to ensure the real-time performance of the interaction in the interaction scenario.

The initiator of the interaction between the first-type client 300 and the second-type client 400 can be either the first-type client 300 and/or the second-type client 400, which is not limited in embodiments of the present disclosure.

When the first-type client 300 only sends data to the first server 100, the first server 100 can convert the data to enable the data to be transmitted to the second server 200 and transmitted by the second server 200. For example, after the first-type client 300 sends data to the first server 100, the data can be configured to be transmitted using the SRT protocol. The first server 100 can convert the data into data that can be transmitted using the WebRTC protocol. Then, the data can be transmitted by the second server 200 using the WebRTC protocol to the second-type client 400.

In some embodiments, the data processing method can also include configuring the first-type client 300 to send data at least to the first server 100 in a second target scenario. The second target scenario can be considered as a live-streaming scenario. For the live-streaming scenario, the first-type client 300 can directly push the data to the first server 100. Transmitting the data using the first transmission protocol can have better low-delay performance and multi-end transmission performance compared to transmitting the data using the second transmission protocol. That is, data can be transmitted to a plurality of ends with low delays. Thus, the restriction on the number of people watching the live streaming can be reduced. The data can be distributed to more third-type clients 500 to solve the current problem of the delay in the live streaming.

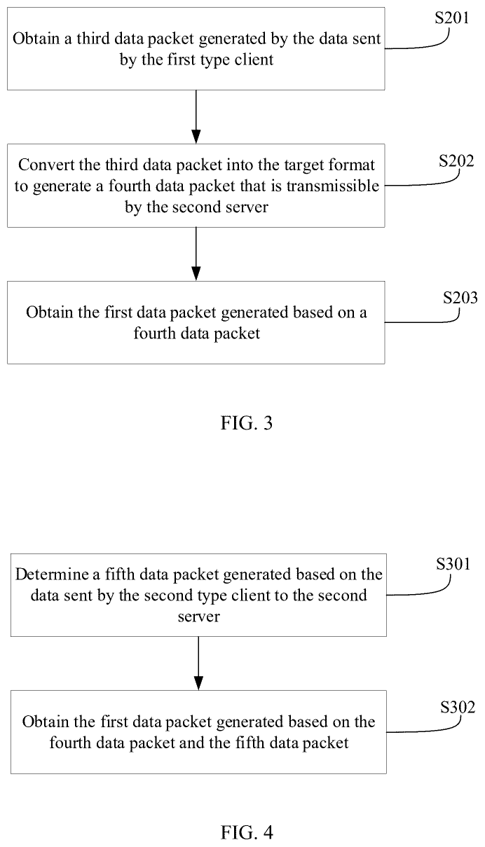

In some embodiments, as shown in FIG. 3, in step S101, obtaining the first data packet transmitted by the second server 200 using the second protocol includes steps S201 to S203.

At S201, a third data packet generated by the data sent by the first-type client 300 is obtained.

At S202, the third data packet is converted into the target format to generate a fourth data packet that is transmissible by the second server 200.

At S203, the first data packet generated based on a fourth data packet is obtained.

Thus, the first server 100 can perform format conversion on the third data packet generated from the data sent from the first-type client 300 to obtain a fourth data packet that can be transmitted by the second server 200. Thus, after the format of the data is converted, the data can be transmitted in real-time using the second transmission protocol configured as the real-time communication protocol to ensure the real-time performance of the interaction between the first-type client 300 and the second-type client 400.

The first-type client 300 can be configured to only send the data to the first server 100. The first server 100 can execute the above steps 201 to 203. Thus, the first server 100 can perform format conversion on the third data packet to obtain the fourth data packet.

After performing the format conversion on the third data packet to generate the fourth data packet, the first server 100 can send the fourth data packet to the second server 200. After the second server 200 obtains the fourth data packet, the first data packet transmitted based on the second transmission protocol can be generated based on the fourth data. Thus, the data sent by the first-type client 300 can be sent to the first server 100 after being converted by the second server 200.

In some embodiments, as shown in FIG. 4, in step 203, obtaining the first data packet generated based on the fourth data packet includes steps S301 and S302.

At S301, a fifth data packet generated based on the data sent by the second-type client 400 to the second server 200 is determined.

At S302, the first data packet generated based on the fourth data packet and the fifth data packet is obtained.

Thus, the data sent by the first-type client 300 to the first server 100 and the data sent by the second-type client 400 to the second server 200 can be processed to obtain the first data packet. The fourth data packet and the fifth data packet can be transmitted based on the second transmission protocol configured as the real-time communication protocol to ensure the real-time performance of the data transmission. That is, the real-time performance of the interaction between the first-type client 300 and the second-type client 400 can be further ensured.

The first data packet can include the interaction content between the first-type client 300 and the second-type client 400. The first data packet can be sent by the second server 200 to the first server 100. The first server 100 can perform the format conversion on the first data packet. Then, the first data packet after the format conversion can be sent to the third-type client 500.

In some embodiments, in step S102, converting the first data packet into the target format to generate the second data packet can include determining the data format of the first data packet and directly converting the first data packet into the second data packet that is able to be transmitted using the first transmission protocol when the data format is the target format.

Thus, when the first data packet is the target format, the first server 100 can directly convert the first data packet into the second data packet to transmit the second data packet to the third-type client 500 with a low delay.

In some embodiments, the data format of the first data packet can include various video transmission formats, for example, a video transmission format based on the MPEG-2 standard, which can include one or more of MPEG-2 TS format, MPEG-2 PS format, and H.264/ACC Packet format. The MPEG-2 PS format is a digital video and audio compression format used for storing and transmitting multimedia data. The H.264/ACC Packet format is a data packet format by combining H.264 video encoding and AAC (Advanced Audio Coding) audio encoding.

For example, the target format above can be the MPEG-2 TS format. When the data format of the first data packet is determined as the MPEG-2 TS format, the MPEG-2 TS format can be directly converted into an SRT Body. The SRT Body refers to the actual audio and video data portion in the SRT protocol, which can be any standard audio or video stream format.

In some embodiments, in step S102, converting the first data packet into the target format to generate the second data packet can include determining the data format of the first data packet and converting the first data packet into the target format to obtain the second data packet transmittable using the first transmission protocol when the data format is not the target format.

Thus, by determining the data format of the first data packet, when the data format of the first data packet is not the target format, the non-target format of the first data packet can be converted into the target format to obtain the second data packet that is able to be transmitted based on the first transmission protocol. Thus, the second data packet can be transmitted to the third-type client 500 at a low delay.

The non-target format can include one or more of MPEG-2 PS format and H.264/ACC Packet format.

For example, when the data format of the first data packet is the MPEG-2 PS format, the MPEG-2 PS format can be converted into the MPEG-2 TS format and sequentially packaged into the SRT Body. In some embodiments, converting the MPEG-2 PS format into the MPEG-2 TS format can include converting the MPEG-2 PS format into the H.264/ACC Packet format and then converting the H.264/ACC Packet format into the MPEG-2 TS format.

For example, if the data format of the first data packet is the H.264/ACC Packet format, the H.264/ACC Packet format can be directly converted into the MPEG-2 TS format and sequentially packaged into the SRT Body. Directly converting the H.264/ACC Packet format into the MPEG-2 TS format can include determining a type of a frame in the first data packet, if the frame is an audio frame, assembling the frame into a PES (Packetized Elementary Stream), if the frame is a video frame, determining whether the video frame is a keyframe, if the video frame is the keyframe, adding a PAT (Program Association Table) and a PMT (Program Map Table), then assembling the video frame into a PES, or if the video frame is not the keyframe, directly assembling the video frame into a PES. Then, the MPEG-2 TS format can be obtained based on the assembled PES.

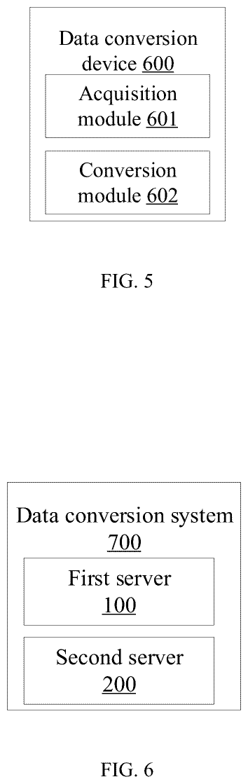

Embodiments of the present disclosure further provide a data processing device 600 applied to the first server 100 using the first transmission protocol. As shown in FIG. 5, the data processing device 600 includes an acquisition module 601 and a conversion module 602. The acquisition module 601 can be configured to obtain the first data packet transmitted by the second server 200 using the second transmission protocol. The first data packet can be at least generated based on the data sent by the first-type client 300 and the second-type client 400. The first-type client 300 can be configured as a control end, and the second-type client 400 can be configured to perform bidirectional interaction with the first-type client 300 using the first interaction content. The conversion module 602 can be configured to convert the first data packet into the target format to generate the second data packet. The second data packet can be configured to be transmitted to the third-type client 500 by the first server 100. The first transmission protocol can be configured as a data transmission protocol. The second transmission protocol can be configured as a real-time communication protocol. The third-type client 500 can be configured to at least perform unidirectional interaction with the first-type client 300 using the second interaction content. The first interaction content and the second interaction content can be different.

In the present disclosure, the first data packet transmitted by the second server 200 using the second transmission protocol can be obtained, and the first data packet can be converted into the target format to generate the second data packet. Thus, the first data packet transmitted based on the second transmission protocol can be converted into the second data packet transmitted based on the first transmission protocol. The second data packet can be transmitted using the first transmission protocol configured as the data transmission protocol to solve the large delay problem. Then, the interaction between the first-type client 300 and the second-type client 400 can be transmitted to the third-type client 500 in real time. Especially for the interaction scenario, the second-type client can send the data to the second server 200 to improve the interaction effect of the interaction scenario. The second-type client 400 can have real-time interaction performance with the first-type client 300, and the third-type client 500 can simultaneously obtain the interaction content.

In some embodiments, the data processing device 600 can further include a processing module. In the first target scenario, the first-type client 300 can be configured to send the data to the first server 100 or to the first server 100 and the second server 200. The second-type client 400 can be configured to send the data to the second server 200.

In some embodiments, the acquisition module 601 can be further configured to obtain the third data packet generated by the data sent by the first-type client 300, convert the third data packet into the target format to generate a fourth data packet that is able to be transmitted by the second server 200, and obtain the first data packet based on the fourth data packet.

In some embodiments, the acquisition module 601 can be further configured to determine a fifth data packet generated from data sent by the second-type client 400 to the second server 200, and obtain the first data packet generated based on the fourth data packet and the fifth data packet.

In some embodiments, the conversion module 602 can be further configured to determine the data format of the first data packet, and, if the data format is the target format, directly convert the first data packet into the second data packet that is able to be transmitted using the first transmission protocol.

In some embodiments, the conversion module 602 can be further configured to determine the data format of the first data packet and, if the data format is not the target format, convert the first data packet into the target format to obtain the second data packet for transmission via the first transmission protocol.

Embodiments of the present disclosure further provide a data processing system 700. As shown in FIG. 6, the data processing system 700 includes the first server 100 and the second server 200 communicatively connected. The second server 200 can be configured to generate the first data packet based on the second transmission protocol. The first data packet can be at least generated based on the data sent by the first-type client 300 and the second-type client 400. The first-type client 300 can be configured as a control end. The second-type client 400 can be configured to perform the bidirectional interaction with the first-type client 300 with the first interaction content. The first server 100 using the first transmission protocol can be configured to receive the first data packet and convert the first data packet into the target format to generate the second data packet that is sent by the first server 100 to the third-type client 500. The first transmission protocol can be configured as the data transmission protocol. The second transmission protocol can be configured as the real-time communication protocol. The third-type client 500 can be configured to at least perform the unidirectional interaction with the first-type client 300 with the second interaction content. The first interaction content can be different from the second interaction content.

In the present disclosure, the first data packet transmitted by the second server 200 using the second transmission protocol can be obtained. The first data packet can be converted into the target format to generate the second data packet. Thus, the first data packet transmitted based on the second transmission protocol can be converted into the second data packet transmitted based on the first transmission protocol. The second data packet can be transmitted out based on the first transmission protocol configured as the data transmission protocol to solve the problem of significant delay. Thus, the interaction between the first-type client 300 and the second-type client 400 can be transmitted to the third-type client in real time. Especially for the interaction scenario, the second-type client 400 can send data to the second server 200 to enhance the interaction effect of the interaction scenario. The second-type client 400 and the first-type client 300 can have real-time interaction, and the third-type client 500 can simultaneously obtain the interaction content.

In some embodiments, in the first target scenario, the first-type client 300 can be configured to send data to the first server 100 or the first server 100 and the second server 200. The second-type client 400 can be configured to send data to the second server 200.

In some embodiments, the first server 100 can be further configured to obtain the third data packet generated from the data sent by the first-type client 300 and convert the third data packet into the target format to generate the fourth data packet that is transmitted by the second server 200. The second server 200 can be further configured to generate the first data packet based on the fourth data packet.

In some embodiments, the second server 200 can be further configured to determine the fifth data packet generated based on the data sent by the second-type client 400 to the second server 200 and obtain the first data packet based on the fourth data packet and fifth data packet.

In some embodiments, the first server 100 can be further configured to determine the data format of the first data packet, and, if the data format is the target format, directly convert the first data packet into the second data packet that is transmitted based on the first transmission protocol.

In some embodiments, the first server 100 can be further configured to determine the data format of the first data packet, and, if the data format is the non-target format, convert the first data packet into the target format to obtain the second data packet that is transmitted based on the first transmission protocol.

In addition, although exemplary embodiments are described in the present specification, the scope of the disclosure includes any and all embodiments with equivalent elements, modifications, omissions, combinations (e.g., cross-combinations of various embodiments), adaptations, or alterations based on the present disclosure. Elements in the claims should be broadly construed based on the language used in the claims and are not limited to examples described in the present specification or during the implementation of the present disclosure. The examples should be non-exclusive.

The above description is intended to be illustrative rather than restrictive. For example, the above examples (or one or more solutions) can be combined with each other for use. For example, those skilled in the art can use other embodiments when reading the above description. In addition, in embodiments of the present disclosure, various features can be grouped together to simplify the present disclosure, which should not be interpreted as an intention to make any unclaimed features necessary for any claim. On the contrary, the subject matter of the present disclosure can have fewer features than all features of a specific disclosed embodiment. Thus, the claims can be incorporated into the specific implementations as examples or embodiments. Each claim can be used as an individual embodiment. Embodiments of the present disclosure can be combined with each other in various groups or sequences. The scope of the present disclosure can be determined with reference to all the scope of the appended claims and the equivalents of the claims.

The above embodiments are exemplary embodiments of the present disclosure and are not intended to limit the present disclosure. The scope of the present disclosure is defined by the claims. Those skilled in the art can make various modifications or equivalent replacements. These modifications or equivalent replacements should be within the scope of the present disclosure.

What is claimed is:

1. A data processing method, applied to a first server using a first transmission protocol, comprising:
obtaining a first data packet transmitted by a second server using a second transmission protocol, the first data packet being generated at least based on data sent by a first-type client and a second-type client, the first-type client being configured as a control end, and the second-type client being configured to interact bidirectionally with the first-type client using a first interaction content; and
converting the first data packet into a target format to generate a second data packet, the second data packet being configured to be transmittable to a third-type client by the first server, the first transmission protocol being configured as a data transmission protocol, and the second transmission protocol being configured as a real-time communication protocol, the third-type client being configured to interact at least unidirectionally with the first-type client using a second interaction content, and the first interaction content being different from the second interaction content.

2. The data processing method of claim 1, wherein:
in a first target scenario, the first-type client is configured to send data to the first server or to the first server and the second server, and the second-type client is configured to send data to the second server.

3. The data processing method of claim 1, wherein obtaining the first data packet transmitted by the second server using the second transmission protocol includes:
obtaining a third data packet generated from data sent by the first-type client;
converting the third data packet into the target format to generate a fourth data packet that is transmittable by the second server; and
generating the first data packet based on the fourth data packet.

4. The data processing method of claim 3, wherein generating the first data packet based on the fourth data packet includes:
determining a fifth data packet generated based on data sent by the second-type client to the second server; and
generating the first data packet based on the fourth data packet and the fifth data packet.

5. The data processing method of claim 1, wherein converting the first data packet into the target format to generate the second data packet includes:
determining a data format of the first data packet; and
in response to the data format being the target format, directly converting the first data packet into the second data packet that is transmitted based on the first transmission protocol.

6. The data processing method of claim 1, wherein converting the first data packet into the target format to generate the second data packet includes:
determining a data format of the first data packet; and
in response to the data format being not the target format, converting the first data packet into the target format to obtain the second data packet that is transmitted based on the first transmission protocol.

7. A data processing device, applied to a first server using a first transmission protocol, comprising:
an acquisition module configured to obtain a first data packet transmitted by a second server using a second transmission protocol, the first data packet being generated at least based on data sent by a first-type client and a second-type client, the first-type client being configured as a control end, and the second-type client being configured to interact bidirectionally with the first-type client using a first interaction content; and
a conversion module configured to convert the first data packet into a target format to generate a second data packet, the second data packet being configured to be transmittable to a third-type client by the first server, the first transmission protocol being configured as a data transmission protocol, and the second transmission protocol being configured as a real-time communication protocol, the third-type client being configured to interact at least unidirectionally with the first-type client using a second interaction content, and the first interaction content being different from the second interaction content.

8. The data processing device of claim 7, wherein:
in a first target scenario, the first-type client is configured to send data to the first server or to the first server and the second server, and the second-type client is configured to send data to the second server.

9. The data processing device of claim 7, wherein:
the acquisition module is further configured to obtain a third data packet generated from data sent by the first-type client; and
the conversion module is further configured to:
convert the third data packet into the target format to generate a fourth data packet that is transmittable by the second server; and
generate the first data packet based on the fourth data packet.

10. The data processing device of claim 9, wherein the acquisition module is further configured to:
determine a fifth data packet generated based on data sent by the second-type client to the second server; and
generate the first data packet based on the fourth data packet and the fifth data packet.

11. The data processing device of claim 7, wherein the conversion module is further configured to:
determine a data format of the first data packet; and
in response to the data format being the target format, directly convert the first data packet into the second data packet that is transmitted based on the first transmission protocol.

12. The data processing device of claim 7, wherein the conversion module is further configured to:
determine a data format of the first data packet; and
in response to the data format being not the target format, convert the first data packet into the target format to obtain the second data packet that is transmitted based on the first transmission protocol.

13. A data processing system comprising:
a second server configured to obtain a first data packet transmitted by a second server using a second transmission protocol, the first data packet being generated at least based on data sent by a first-type client and a second-type client, the first-type client being configured as a control end, and the second-type client being configured to interact bidirectionally with the first-type client using a first interaction content; and
a first server communicatively connected to the second server, using a first transmission protocol, and configured to convert the first data packet into a target format to generate a second data packet, the second data packet being configured to be transmittable to a third-type client by the first server, the first transmission protocol being configured as a data transmission protocol, and the second transmission protocol being configured as a real-time communication protocol, the third-type client being configured to interact at least unidirectionally with the first-type client using a second interaction content, and the first interaction content being different from the second interaction content.

14. The data processing system of claim 13, wherein:
in a first target scenario, the first-type client is configured to send data to the first server or to the first server and the second server, and the second-type client is configured to send data to the second server.

15. The data processing system of claim 13, wherein:
the first server is further configured to obtain a third data packet generated from data sent by the first-type client and convert the third data packet into the target format to generate a fourth data packet that is transmittable by the second server; and
the second server is further configured to generate the first data packet based on the fourth data packet.

16. The data processing system of claim 15, wherein the second server is further configured to:
determine a fifth data packet generated based on data sent by the second-type client to the second server; and
generate the first data packet based on the fourth data packet and the fifth data packet.

17. The data processing system of claim 13, wherein the first server is further configured to:
determine a data format of the first data packet; and
in response to the data format being the target format, directly convert the first data packet into the second data packet that is transmitted based on the first transmission protocol.

18. The data processing system of claim 13, wherein the first server is further configured to:
determine a data format of the first data packet; and
in response to the data format being not the target format, convert the first data packet into the target format to obtain the second data packet that is transmitted based on the first transmission protocol.
